(19) United States
(12) Patent Application Publication
(10) Pub. No.: US 2007/0226420 A1
(43) Pub. Date: Sep. 27, 2007

(54) Compression method and apparatus for a CPU

(76) Inventor: Chih-Ta Star Sung, Glonn (DE)

Correspondence Address: Chih-Ta Star SUNG;RM. 308, BLD. 52, NO. 195, CHUNG HSING RD., SEC. 4, CHU TUNG TOWNSHIP, HSINCHU COUNTY, 310, TW

(21) Appl. No.: 11/385,576

(22) Filed: Mar. 22, 2006

(51) Int. Cl. G06F 13/00; G06F 12/00

(52) U.S. Cl. 711/123; 711/154; 711/202

(57) ABSTRACT

A compression method and apparatus compresses the program and data for a CPU which significantly reduces the density of storage device of storing the program and the data for a CPU to execute the program. Multiple groups of instructions and data are compressed separately by a mapping unit indicating the starting location of a group of instructions and data set s which helps quickly recovering the corresponding instructions and data. In decoding, multiple instructions and data are decoded in parallel to quickly recover instructions and data to avoid running out of instruction and data in the file register. A mapping unit is used to translate the corresponding address of a group of data for quickly recovering the corresponding data for the file register file to avoid running out of data for a CPU to execute.

### BACKGROUND OF THE INVENTION

1. Field of Invention

The present invention relates to the data compression and decompression method and device, and particularly relates to the compression specifically for reducing the density of the program memory and data memory within a CPU which results in a die area reduction and higher performance.

2. Description of Related Art

In the past decades, the continuous semiconductor technology migration trend has driven wider and wider applications including internet, the digital image and video, digital audio and display. Consumer electronic products consume high amount of semiconductor components including digital camera, video recorder, 3G mobile phone, VCD, DVD, Set-top-box, Digital TV, . . . etc.

Some products are implemented by hardware devices, while, another high percentage of product functions and applications are realized by executing a software or firmware program embedded within a CPU, Central Processing Unit or a DSP, Digital Signal Processing engine.

Advantage of using software and/or firmware to implement desired functions includes flexibility and better compatibility with wider applications by re-programming. While, the disadvantage includes higher cost of storage device of program memory which store a large amount of instructions of execution for a specific function. For example, a hard wire designed ASIC block of a JPEG decoder might costs only 40,000 logic gate, while a total of 128,000 Byte of execution code might be needed for executing the decompression function of JPEG picture decompression which is equivalent to about 1 M bits and 3M logic gate if all instructions are stored on the CPU chip. If a complete program is stored in a program memory, or so called “I-Cache” (Instruction Cache), the memory density might be too high. If partial program is stored in the I-cache, when cache missed, the time of moving the program from an off-chip to the on-chip CPU might cost long delay time and higher power will be dissipated in I/O pad data transferring. Another problem is the data memory, or so names the “D-Cache” dominates an unintelligible size of memory.

This invention of data compression reduced the required density of cache memory which overcomes the disadvantage of the existing CPU with less density of caching memory and higher performance when cache miss happens and also reduces the times of transferring data from an off-chip program memory to the on-chip cache memory and saves power consumption.

### SUMMARY OF THE INVENTION

The present invention of the high efficiency data compression method and apparatus significantly reduces the requirement of the memory density of the program memory and/or data memory of a CPU. When “cache miss” happens, with this invention, the times of transferring other instructions from another storage device to the current CPU is significantly reduced.
The present invention reduces the requirement of density of the caching memory of a CPU by compressing I-cache.
The present invention reduces the requirement of density of the caching memory of a CPU by compressing D-cache.
When a CPU is executing a program, the I-cache and/or D-cache decompression engine of this invention decodes the compression instruction and/or data and fill into the “File Register” for CPU to execute the appropriate instruction with corresponding data.
According to an embodiment of the present invention, multiple instructions are buffered and the decoder recovers the instruction with variable length of time each instruction and temporarily stores them into a buffer and filling to the “File Register” for the CPU to execute.
According to an embodiment of the present invention, a group of instructions are compressed and buffered to ensure that the “File Register” will not be short of instruction in running a program.
According to an embodiment of the present invention, the uncompressed data can be compressed by higher compression rate and fill into the D-cache memory.
According to an embodiment of the present invention a dictionary like storage device is used to store the pattern not shown in previous pattern.
According to an embodiment of the present invention, a comparing engine receives the coming instruction and searches for a matching instruction in the previous instructions.
According to an embodiment of the present invention, a mapping unit indicates the starting location of a group of instruction and a group of data for quickly recovering the corresponding instructions and data.

Other aspects and advantages of the present invention will become apparent from the following detailed description, taken in conjunction with the accompanying drawings, illustrating by way of example the principles of the invention. It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of the data flow of a CPU.

FIG. 2 shows the principle of the invention of compression instruction and data going to a CPU.

FIG. 3 illustrates a basic instruction set of a CPU

FIG. 4 illustrates procedure of a CPU executing a program

FIG. 5 illustrates Procedure of Decoding a program and filling the File Register for CPU execution.

FIG. 6 shows the Block diagram of compressing the program for I-cache memory.

FIG. 7 illustrates Block diagram of decoding the compressed instruction.

FIG. 8 depicts Block diagram of compressing the program for D-cache memory.

FIG. 9 shows the block diagram of decoding the compressed data.

FIG. 10 illustrates a procedure of the compressing the I-Cache.

FIG. 11 shows the address mapping which translates the address of the instruction and data to the corresponding group of compressed instruction and data and recovers the corresponding instructions and data.

### DESCRIPTION OF THE PREFERRED EMBODIMENTS

Due to the fact that the performance of the semiconductor technology has since the invention of the transistor continuously doubled every around 18 months, wide applications including internet, wireless LAN, digital image, audio and video becomes feasible and created huge market including mobile phone, internet, digital camera, video recorder, 3G mobile phone, VCD, DVD, Set-top-box, Digital TV, . . . etc. Some electronic devices are implemented by hardware devices, some are realized by CPU or DSP engine by executing the software or the firmware. Due to the momentum of semiconductor technology migration, coupled with short time to market, CPU and DSP solution becomes more popular in the competitive market.

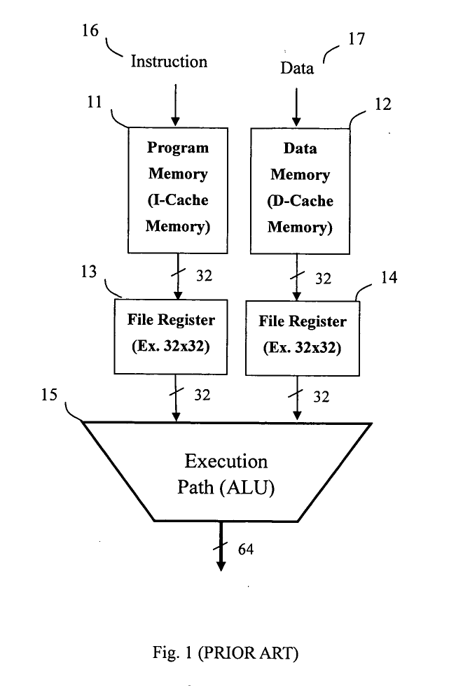

Due to the factor that variable applications require variable length of programs which in some cases should be partitioned and part of them be stored in an on-chip “cache memory” since transferring instructions from an off-chip to the CPU causes long delay time and consumes high power. Therefore, most CPU has a storage device called cache memory for buffering execution code of the program and the data. The cache used to store the program is also named “Instruction Cache” or simply named “I-Cache” while the cache storing the data set is called “Data Cache” or “D-Cache”. FIG. 1 shows the prior art principle of how a CPU executes a program. A program is comprised a certain amount of “Instruction” sets 16 and data sets 17 which are the sources and codes of the CPU execution. An “Instruction” instructs the CPU what to work on. The instructions of program are saved in an on-chip program memory, or so called I-Cache memory 11, while the corresponding data which a program needs to execute are saved in an on-chip data memory, or so called D-Cache memory 12. The “Caching Memory” might be organized to be large bank with heavy capacitive loading and relatively slow in accessing compared to the execution speed of the CPU execution logic, therefore, another temporary buffer of so named “File Register” 13, 14 with most likely smaller size, for example 32×32 (32 bits wide instruction or data times 32 rows) is placed between the CPU execution path 15 and the caching memory. The CPU execution path will have some basic ALU functions like AND, NAND, OR, NOR, XOR, Shift, Round, Mod . . . etc, some might have multiplication and data packing and aligning features.

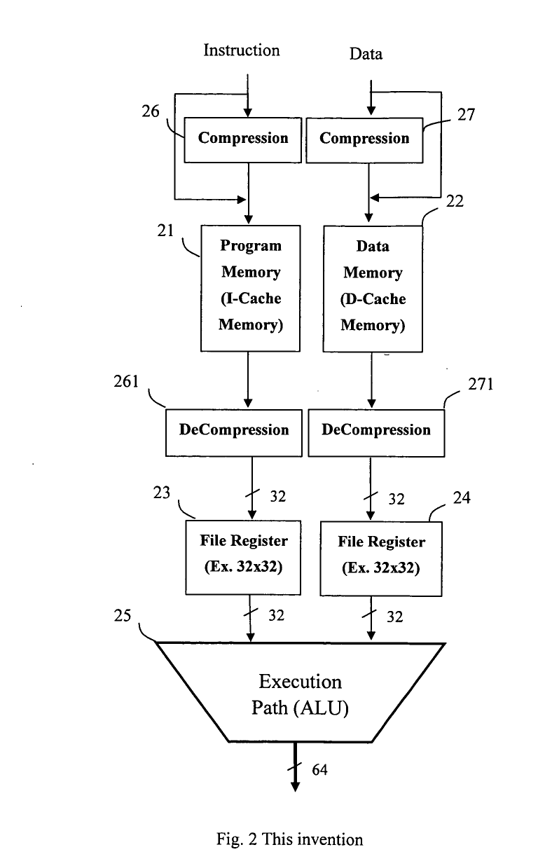

Since the program memory and data memory costs high percentage of die area of a CPU in most applications, this invention reduces the requirements of the program memory density and/or data memory by compressing the CPU instructions and data. The key procedure of this invention is illustrated in FIG. 2. The instruction and/or data is compressed 26, 27 before being stored into the program memory 21 and data memory 22. When a scheduled time matched for executing the program or data, the compressed instruction and data is decompressed 261, 271 and fed to the file register 23, 24 which is a smaller temporary buffer next to the execution unit 25 of the CPU. The instruction or data can also be compressed by other machine before being fed into the CPU engine. If the coming instruction or data is compressed before, then, the compressed instruction or data can bypass the compression step and directly feeds to the program/data memory. (I-cache, D-cache).

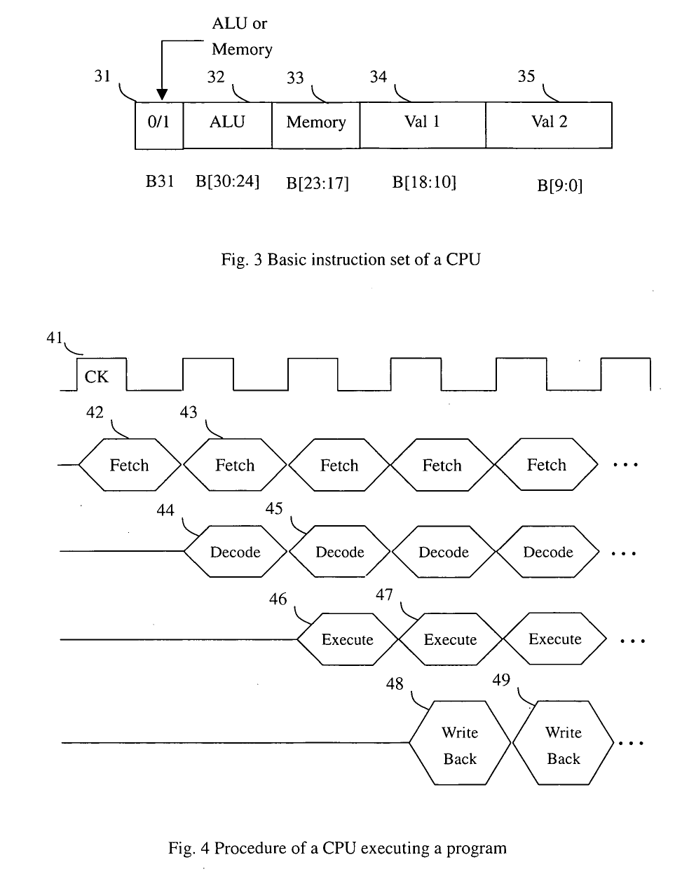

FIG. 3 briefly illustrates the principle of a CPU instruction which most cases has divided to be ALU function and memory 33 related function and uses a bit 31 to represent the current instruction if ALU 32 or Memory 33. Many instructions have attached numbers for operation which might be a direct values 34, 45 of operand or address or displacement of another address or data value.

FIG. 4 illustrates the basic procedure of how a CPU pipelining executes a program. All procedures are synchronized with the common clock, or named CLK 41. The 1^{st} stage is to “Fetch” instructions 42, 43. The fetched instruction will be decoded by the “Decode” stage 44, 45, afterward, the function of an instruction will be interpreted and loaded to the CPU for execution. The decoded instruction is fed to the execution path to execute 46, 47 according to the instruction. The executed results of data might be sent back to the cache memory for storage, this stage is named “Write Back” 48, 49. Fetching, decoding, execution and writing back are basic operations of a CPU, for achieving higher performance without stop and wait each stage of the CPU runs in parallel or so called pipelining.

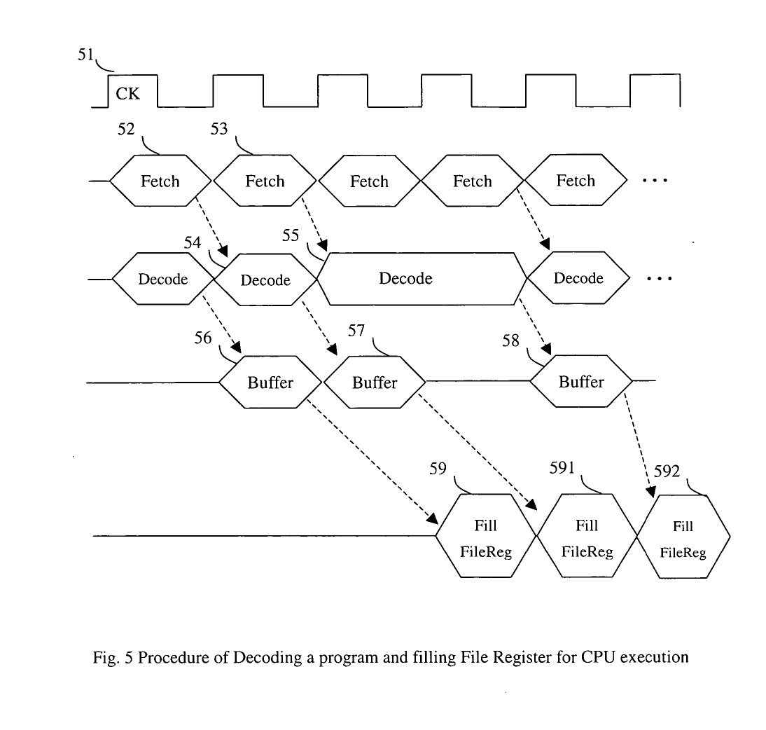

In this invention, the program of instruction sets is compressed before saving to the cache memory. Some instructions ate simple, some are not. The simple instruction can be compressed also in pipelining, while some instructions are related to other instructions' results and require more computing times of execution. Decompressing the compressed program saved in the cache memory also has variable length of computing times for different instructions. FIG. 5 illustrates the concept of this invention of decompressing the compressed and filling into the “File Register” which is directly fed to CPU for execution. The compressed instructions are fetched 52, 53 continuously from the cache memory and decoded by variable length of computing times 54, 55, the decoded instructions are buffered 56, 57, 58 to ensure all instructions are already recovered and are fed into the “File Register” 59, 591, 592 for CPU to execute. Some instructions have correlation with other instructions and/or “Condition” to check which cause longer times 53 of decoding.

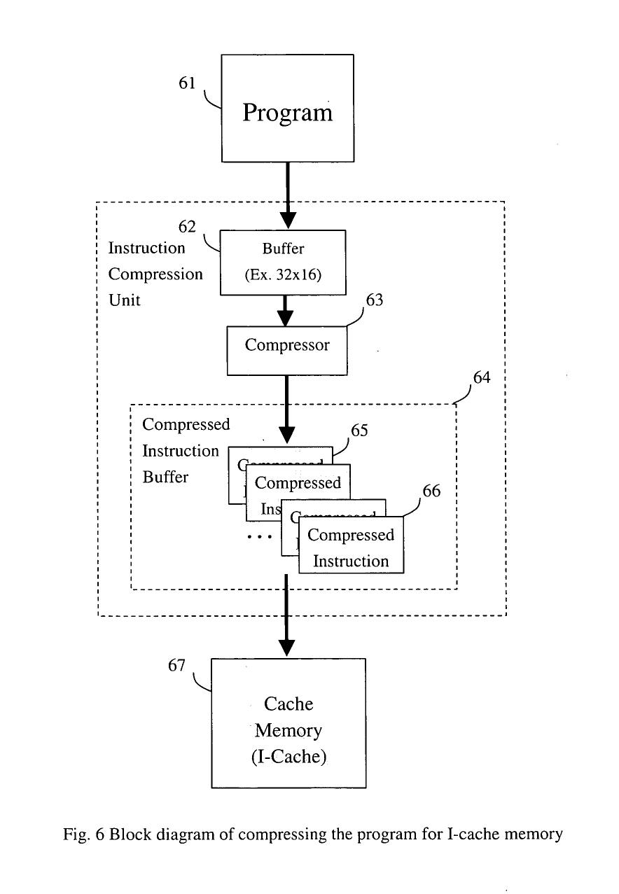

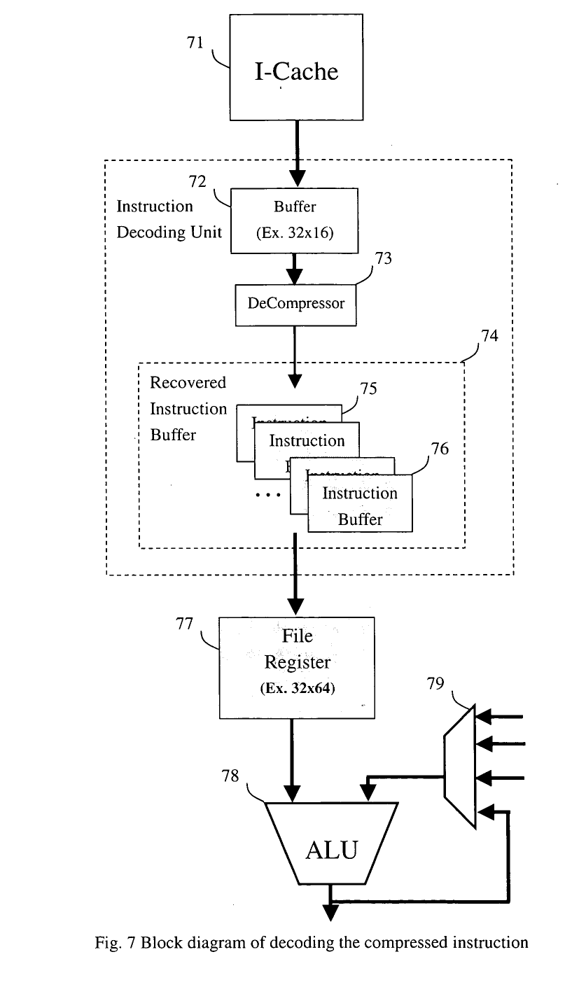

In some applications of this invention of I-cache or D-cache memory compression, a program or data sets can be compressed by the built-in on-chip compressor, some can be done by other off-chip CPU engine. Both ways of compressing the instruction or data, the compressed program and data set can be saved in the cache memory and decompressed by an on-chip decompression unit. FIG. 6 depicts the way the compression is done by an on-chip compressor. The program 61 is compressed before being saved into the I-cache memory. Some instructions random access other instruction or location, for instance, “Jump”, “Go To”, for achieving higher performance, a predetermined depth of buffer 62 or named FIFO (First in, first out), for example, 32×16 bits is design to temporarily store the instructions, and send the instruction to the compressor 63 for compression. For random accessing the instruction and quickly decoding the compressed instructions, the compressor compresses the instructions with each group of instruction with a predetermine length and the compressed instructions 65, 66 are buffered by a buffer 64 before being stored to the cache memory 67. FIG. 7 shows the reverse path of decompressing the instructions and filling the “File Register” for execution. The compressed instructions stored in the I-Cache memory is input to the DeCompressing unit which includes a predetermined amount of buffer, for instance a 32×16 bits, a DeCompressor and a predetermined amount 75, 76 of the buffer of recovered instructions 74 or so named FIFO. The recovered instructions are fed into the “File Register” 77 which a temporary buffer before the execution path, or so names ALU, Arithmetic and Logic Unit 78. Some instructions wait the result of previous instruction and combine other data which is selected by a multiplexer 79 to determine which data to be fed to the execution unit again.

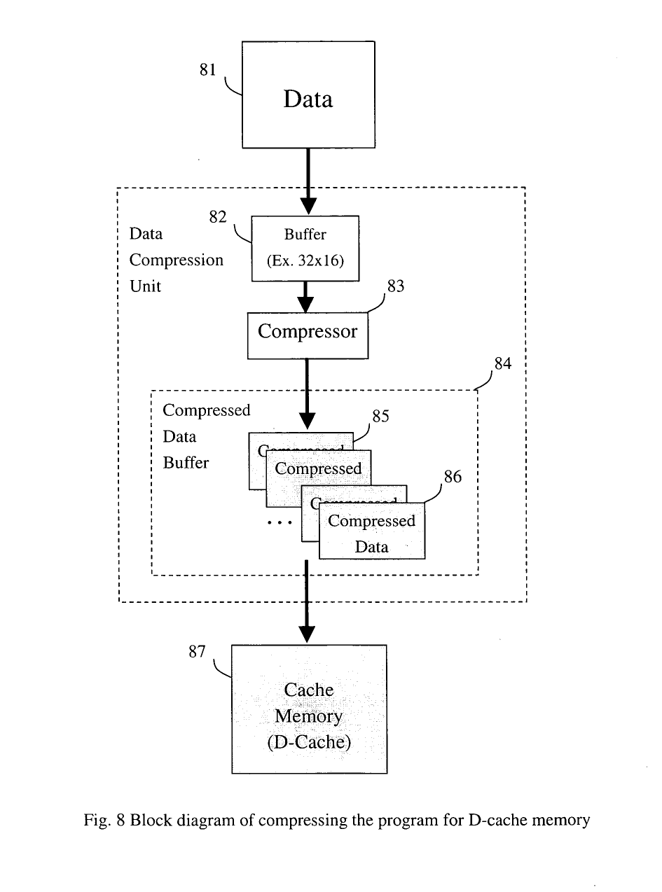

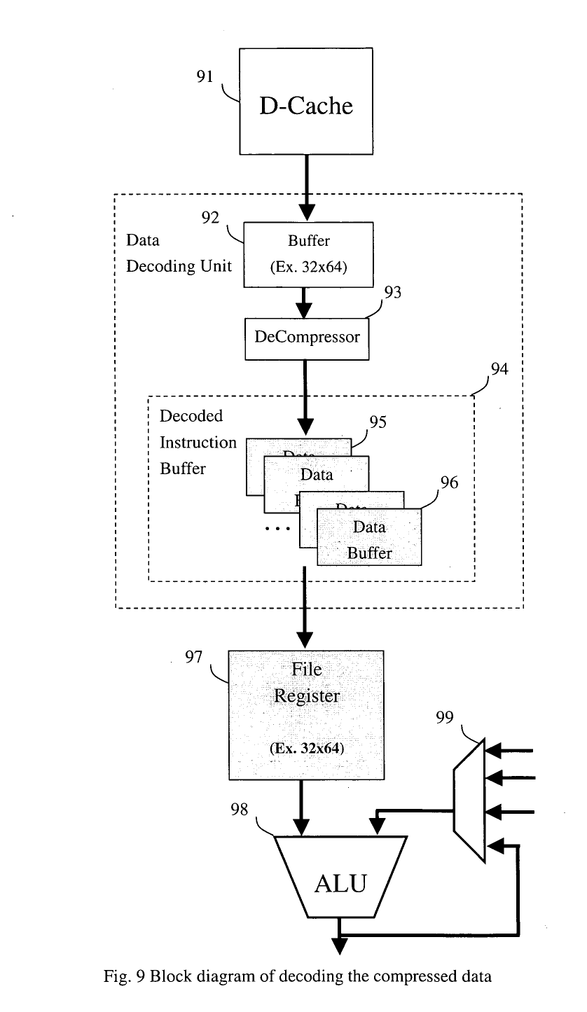

Similar to the compression and decompression of the program, the data set in this invention can also be compressed and stored to the D-Cache memory and decompressed for execution. FIG. 8 shows the procedure of the compression of the D-Cache. The data sets 81 are compressed before being saved into the D-cache memory. Some data set might random access other instruction and data. For achieving higher performance, a predetermined depth of buffer 82 or named FIFO (First in, first out), for example, 32×16 bits is design to temporarily store the data, and send the data to the compressor 83 for compression. For random accessing the data set and quickly decoding the compression data set, the compressor compresses the instructions with each group of data with a predetermine amount of data 85, 86 are buffered by a data buffer 84 before being stored to the cache memory 87. FIG. 9 shows the reverse path of decompressing the data set and filling the “File Register” for execution. The compressed data stored in the D-Cache 91 memory is input to the DeCompressing unit 93 which includes a predetermined amount of buffer, for instance a 32×16 bits, a DeCompressor and a predetermined amount 95, 96 of the buffer of recovered data 94 or so named FIFO. The recovered data sets are fed into the “File Register” 97 which is a temporary buffer before the execution path, or so names ALU, Arithmetic and Logic Unit 98. Some instructions wait the result of previous instruction and combine other data which is selected by a multiplexer 99 to determine which data to be fed to the execution unit.

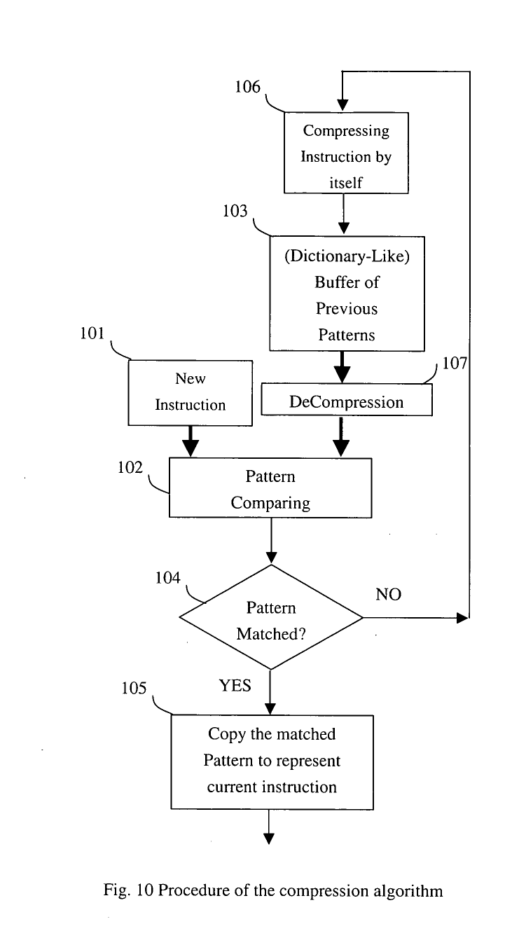

FIG. 10 illustrates the procedure of the compression of a program. A new instruction 101 is compared 102 to the previous instructions to decide whether a match happens. If a match happens 104, the corresponding previous instruction is copied 105 to represent the current instruction. If no matching, the current instruction can still be compressed by information within itself 106 by come compression methods including but not limited to “Run-Length” coding, entropy coding, . . . etc. A dictionary like buffer 103 with predetermined amount of bits is designed to store the previous instructions. To achieve higher compression rate, the previous instructions are compressed before saving to the buffer. And will be decompressed 107 again before output to be compared to the new instruction. Theoretically, the larger the buffer, the more instructions it can save and the higher probability it can find a matching instruction from with the cost of higher die area. So, there will be tradeoff in most applications in determining the size of the buffer of storing previous instructions.

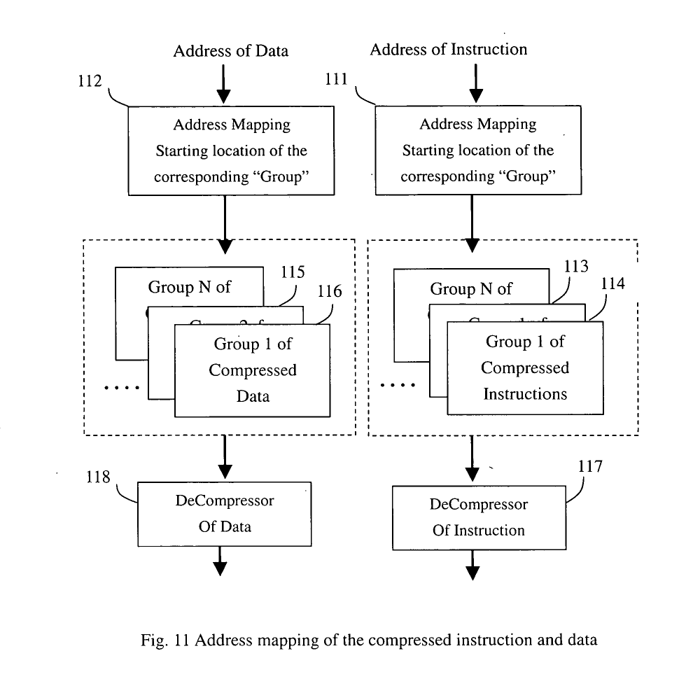

Many programs will access some storage devices with predetermined address. In this invention, since instruction and/or data are compressed, and are no longer exact address of original programs, for quick accessing the instructions and data, predetermined amount of instructions and data are compressed as a “Group” with a predetermined compression rate. Therefore, as shown in FIG. 11, the accessing address of either the instruction or data will be interpreted by an address mapping units 111, 112 and a corresponding starting address of the “Group” of instruction 113, 114 or data 115, 116 will be calculated and be accessed. The corresponding group of instructions 117 and/or data 118 will then be decompressed to be fed into the corresponding File Registers. The group of compressed instructions and data can be decompressed in a parallel to achieve a high recovering speed and to avoid long waiting time.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of executing a program of a CPU, comprising:
If the program is comprised of uncompressed instructions, then
compressing the program and storing the compressed instruction into the first storage device;
fetching the compressed instruction from the first storage device and decompressing the compressed instruction; and
storing the decompressed instruction into the second storage device which directly connect to the CPU for execution.
If the program is comprised of compressed instructions, then
storing the compressed instruction into the first storage device;
fetching the compressed instruction from the first storage device and decompressing the compressed instruction; and
storing the decompressed instruction into the second storage device which directly connects to the CPU for execution.

2. The method of claim 1, wherein a program can be compressed by other CPU engine before input to another CPU.

3. The method of claim 1, wherein multiple instructions can be compressed and decompressed in parallel and saved as a group of instructions.

4. The method of claim 1, wherein a temporary storage device comprising of multiple registers are used to buffer the decompressed instructions for continuously filling the second storage device for CPU to directly execute the program without running out of instruction;

5. The method of claim 1, wherein in compressing an uncompressed program, a temporary storage device comprising of multiple registers are used to buffer the uncompressed instructions.

6. The method of claim 1, wherein in compressing an uncompressed program, a temporary storage device comprising of multiple registers are used to buffer the compressed instructions and store to the first storage device which has higher density than the second storage device.

7. The method of claim 1, wherein in compressing an uncompressed program, a new instruction is compared to previous instructions saved in a storage device to determine if a previous instruction can be used to represent the current instruction.

8. The method of claim 1, wherein in compressing an uncompressed program, if current instruction finds no matching from previous instructions, the current instruction is compressed by information of itself and saves into the buffer which temporarily stores previous instructions.

9. The method of claim 1, wherein when cache miss happens in executing a program within a CPU, other instructions stored in other device are transferred to the CPU, if the instructions is compressed it is stored to the cache memory, if uncompressed, it is compressed and stored to the cache memory.

10. A method of accessing the data memory of a CPU, comprising:
compressing the data and storing the compressed data into the first storage device;
fetching the compressed data from the first storage device and decompressing the compressed data; and
storing the decompressed data into the second storage device which directly connects to the CPU for execution.

11. The method of claim 10, wherein no matter the input data is compressed or uncompressed data, it is compressed and stored to the second storage device as compressed data.

12. The method of claim 10, wherein the input data is an uncompressed audio and image data with PCM audio formats, Red, Green and Blue image format or Y, U and V image format.

13. The method of claim 10, wherein the input data is a compressed still image data stream.

14. The method of claim 10, wherein the input data is a compressed motion video data stream.

15. An apparatus of storing and executing a program in a CPU with reduced density of storage device, comprising
a compression unit to reduce the length of instruction or data which are temporarily stored in the first buffer;
a cache memory to store the compressed instruction or data receiving from the compression unit;
a decompression unit to recover the instruction or data receiving from the cache memory;
a file register to store the instruction or data which is coupled between the cache memory and the execution unit of the CPU; and
an execution unit of a CPU to execute the instruction and data;

16. The apparatus of claim 15, wherein the compression unit compresses the instruction with variable length of calculating times and stores the compassed instructions into a temporary buffer before sending the compressed instruction to a cache memory.

17. The apparatus of claim 15, wherein the decompression unit decompresses the instructions with variable length of calculating times and stores the decompressed instructions into a temporary buffer before sending the decompressed instruction to a file register.

18. The apparatus of claim 15, wherein the compression unit reduces the length of instruction and requires less cache memory density, comprising
a storage device which saves previous instructions;
a comparing unit determines whether an instruction of previous instructions matches current instruction; and
if a match is found, then, the corresponding instruction saved in the storage device is used to represent the current instruction, if no match, the current instruction is compressed by itself and saved into the storage device which is used to save previous instruction.

19. The apparatus of claim 15, wherein a mapping unit indicates the starting location of a group of compressed instructions and data for more quickly recovering the corresponding instructions and data.

20. The apparatus of claim 15, wherein during decompressing instructions correlating to other instructions or data, a group of compressed instructions are decompressed in parallel to quickly recover the corresponding instructions and data sets for recovering the current instruction.
